(19) United States
(12) Patent Application Publication
(10) Pub. No.: US 2018/0094486 A1
(43) Pub. Date: Apr. 5, 2018

(54) ELECTROMECHANICAL LADDER

(71) Applicant: Brandon J. Bower, Worland, WY (US)

(72) Inventor: Brandon J. Bower, Worland, WY (US)

(21) Appl. No.: 15/283,642

(22) Filed: Oct. 3, 2016

(51) Int. Cl. E06C 7/12; B66F 3/44

(52) U.S. Cl. CPC E06C 7/12; B66F 3/44

(57) ABSTRACT

An electromechanical ladder to raise and lower a step is provided that includes: (i) a front frame, (ii) a collapsible rear frame, (iii) one or more expandable brace members, (iv) a set of two or more wheels, (v) a first hand rail, (vi) a second hand rail, (vii) a first function button, (viii) a second function button, (ix) a first lead screw, (x) a second lead screw, (xi) a compartment, (xii) a reversible motor, (xiii) a sprocket, (xiv) a first drive chain, and (xv) a second drive chain. The step couples in between the front frame and the collapsible rear frame. The one or more expandable brace members prevent the collapsible rear frame from getting collapsed. The set of two or more wheels allow a user to carry the electromechanical ladder from one place to another. The first hand rail and the second hand rail provide a support to the user. The first function button raises the step up when the user presses the first function button. The second function button lowers the step down when the user presses the second function button. The compartment includes (i) a power button, (ii) a fuse, (iii) a rechargeable battery, and (iv) a printed circuit board. The power button turns the electromechanical ladder ON and OFF. The fuse prevents damage to the electromechanical ladder. The rechargeable battery drives the electromechanical ladder. The printed circuit board includes: (i) one or more resistors, (ii) one or more capacitors, and (iii) one or more relays. The reversible motor rotates in clockwise direction and anticlockwise direction. The sprocket couples to the reversible motor. The first drive chain and the second drive chain rotate in same direction with same speed simultaneously. The first drive chain and the second drive chain rotate the first drive gear and the second drive gear simultaneously in the same direction. The first drive gear and the second drive gear transfer the rotary motion to the first lead screw and the second lead screw simultaneously in the same direction with the same speed.

### BACKGROUND

### Technical Field

The embodiment herein generally relates to a ladder, and more particularly to an electromechanical ladder.

### Description of the Related Art

A ladder is a vertical or an inclined structure made up of several steps and a frame to assist in climbing the walls of a house, building or the like. A user finds it easy to climb up using a ladder to put the household stuff at a particular height. The user may find difficulty in climbing if the user is suffering from arthritis or some sort of physical disability. Even old aged cannot climb up the ladder. Moreover, for a fit user, it demands a lot of physical work to ascend and descend the ladder repeatedly.

Accordingly, there remains a need for a cheap and efficient ladder that assists the user to climb the heights without any physical efforts.

### SUMMARY

In view of the foregoing, an embodiment herein provides an electromechanical ladder to raise and lower a step. The electromechanical ladder includes: (i) a front frame, (ii) a rear frame, (iii) one or more expandable brace members, (iv) a set of two or more wheels, (v) a first hand rail, (vi) a second hand rail, (vii) a first function button, (viii) a second function button, (ix) a first lead screw, (x) a second lead screw, (xi) a compartment, (xii) a motor, (xiii) a sprocket, (xiv) a first drive chain, and (xv) a second drive chain. The step couples in between the front frame and the rear frame. The one or more expandable brace members prevent the rear frame from getting collapsed. The set of two or more wheels allow a user to carry the electromechanical ladder from one place to another. The first hand rail and the second hand rail provide a support to the user. The first function button raises the step up when the user presses the first function button. The second function button lowers the step down when the user presses the second function button. The compartment includes (i) a power button, (ii) a fuse, (iii) a battery, and (iv) a printed circuit board. The power button turns the electromechanical ladder ON and OFF. The fuse prevents damage to the electromechanical ladder. The battery drives the electromechanical ladder. The printed circuit board includes: (i) one or more resistors, (ii) one or more capacitors, and (iii) one or more relays. The motor rotates in clockwise direction and anticlockwise direction. The sprocket couples to the motor. The first drive chain and the second drive chain are adapted to rotate in same direction with same speed simultaneously. The first drive chain and the second drive chain rotate the first drive gear and the second drive gear simultaneously in the same direction. The first drive gear and the second drive gear transfer the rotary motion to the first lead screw and the second lead screw simultaneously in the same direction with the same speed.

In another aspect of the electromechanical ladder, the rear frame of the electromechanical ladder is collapsible. The first lead screw and the second lead screw are square thread type lead screw. In one embodiment, the battery is a set of one or more rechargeable batteries. The motor is a reversible motor. In another embodiment, the motor rotates in clockwise direction when the user presses the first function button and in anticlockwise direction when the user presses the second function button.

An electromechanical ladder to raise and lower a step is provided that includes: (i) a front frame, (ii) a collapsible rear frame, (iii) one or more expandable brace members, (iv) a set of two or more wheels, (v) a first hand rail, (vi) a second hand rail, (vii) a first function button, (viii) a second function button, (ix) a first lead screw, (x) a second lead screw, (xi) a compartment, (xii) a reversible motor, (xiii) a sprocket, (xiv) a first drive chain, and (xv) a second drive chain. The step couples in between the front frame and the collapsible rear frame. The one or more expandable brace members prevent the collapsible rear frame from getting collapsed. The set of two or more wheels allow a user to carry the electromechanical ladder from one place to another. The first hand rail and the second hand rail provide a support to the user. The first function button raises the step up when the user presses the first function button. The second function button lowers the step down when the user presses the second function button. The compartment includes (i) a power button, (ii) a fuse, (iii) a rechargeable battery, and (iv) a printed circuit board. The power button turns the electromechanical ladder ON and OFF. The fuse prevents damage to the electromechanical ladder. The rechargeable battery drives the electromechanical ladder. The printed circuit board includes: (i) one or more resistors, (ii) one or more capacitors, and (iii) one or more relays. The reversible motor rotates in clockwise direction and anticlockwise direction. The sprocket couples to the reversible motor. The first drive chain and the second drive chain are adapted to rotate in same direction with same speed simultaneously. The first drive chain and the second drive chain rotate the first drive gear and the second drive gear simultaneously in the same direction. The first drive gear and the second drive gear transfer the rotary motion to the first lead screw and the second lead screw simultaneously in the same direction with the same speed.

In another aspect of the electromechanical ladder, the first lead screw and the second lead screw are square thread type lead screw. The reversible motor rotates in clockwise direction when the user presses the first function button and in anticlockwise direction when the user presses the second function button.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof and the embodiments herein include all such modifications.

### BRIEF DESCRIPTION OF THE DRAWINGS

The embodiments herein will be better understood from the following detailed description with reference to the drawings, in which:

FIG. 1 is a perspective view of an electromechanical ladder with a step according to an embodiment herein;

FIG. 1A is a diagrammatic view of a first guide of FIG. 1 according to an embodiment herein;

FIG. 2 is a perspective view of rear side of the front frame illustrating a drive mechanism for the electromechanical ladder of FIG. 1 according to an embodiment herein; and

FIG. 3 is a perspective view of bottom side of the front frame of the electromechanical ladder of FIG. 1 according to an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

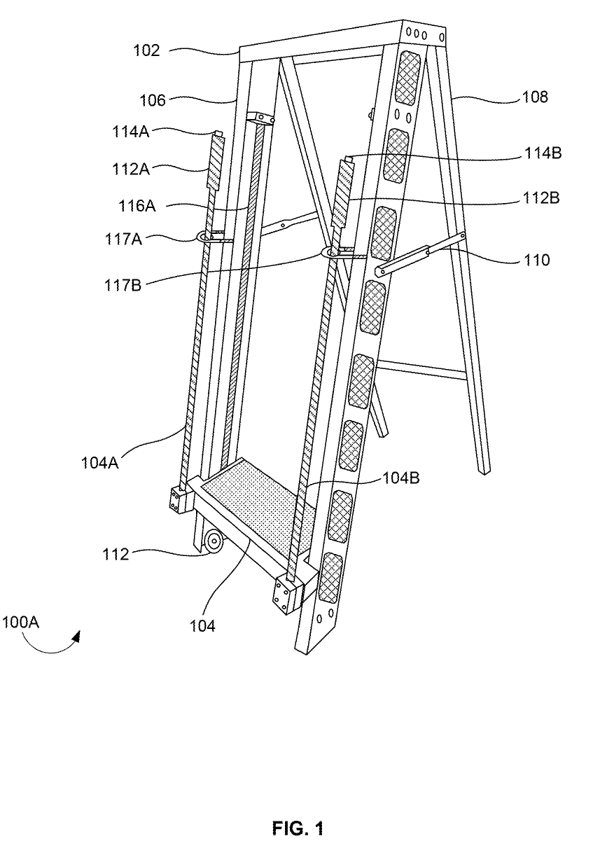

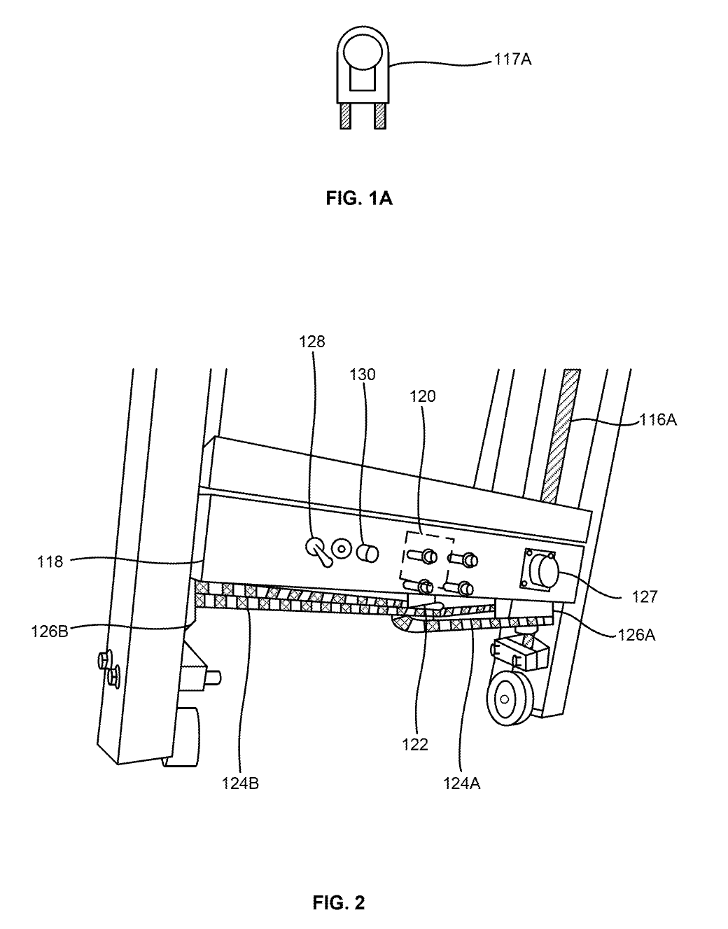

As mentioned, there remains a need for a cheap and efficient ladder that assists a user to climb the heights. The embodiments herein achieve this by providing a ladder with single step. The user step attains different heights by electromechanical means. Referring now to the drawings, and more particularly to FIGS. 1 through 2, where similar reference characters denote corresponding features consistently throughout the figures, there are shown preferred embodiments.

FIG. 1 is a perspective view 100A of an electromechanical ladder 102 with a step 104 according to an embodiment herein. The electromechanical ladder 102 includes the step 104, a front frame 106, a rear frame 108, one or more expandable brace members 110 and a set of two or more wheels 112. The step 104 couples in between a pair of two legs of the front frame 106. A user steps over the step 104 to get up. In one embodiment, the step 104 couples an anti-slip layer to prevent the user from getting slipped. The rear frame 108 supports the front frame 106 to get balanced. In one embodiment, the rear frame 108 is collapsible. In another embodiment, the rear frame 108 may have one or more legs. The one or more expandable brace members 110 prevent the rear frame 108 from getting collapsed while the user steps over the step 104 of the electromechanical ladder 102. The set of two or more wheels 112 provides the flexibility to the user to carry the electromechanical ladder 102 from one place to another.

The electromechanical ladder 102 further includes a first hand rail 112A, a second hand rail 112B, a first function button 114A, a second function button 114B, a first lead screw 116A, a second lead screw (not shown in FIG. 1), a first guide 117A and a second guide 117B. The first hand rail 112A and the second hand rail 112B are provided for the user to hold while the user is standing on the step 104. The user presses the first function button 114A to raise the step 104 of the electromechanical ladder 102 and presses the second function button 114B to lower the step 104 of the electromechanical ladder 102. The first lead screw 116A is arranged in a left leg of the front frame 106 and the second lead screw is arranged in a right leg of the front frame 106. The first lead screw 116A and the second lead screw are square thread type lead screws. When the user presses either of the first function button 114A and the second function button 114B, a first drive chain (not shown in FIG. 1) and a second drive chain (not shown in FIG. 1) rotate in the same direction and with same speed.

FIG. 1A is a diagrammatic view of the first guide 117A of FIG. 1 according to an embodiment herein. The first guide 117A couples to the front frame 106 using a frame. In one embodiment, the second guide 117B couples to the front frame 106 using the same frame. The first guide 117A and the second guide 117B keep the first lead screw 116A and the second lead screw 116B respectively, in vertical position and prevent undesired movements of the first lead screw 116A and the second lead screw 116B.

FIG. 2 is a perspective view 100B of rear side of the front frame 106 illustrating a drive mechanism for the electromechanical ladder 102 of FIG. 1 according to an embodiment herein. The electromechanical ladder 102 includes a compartment 118, a reversible motor 120, a sprocket 122, the first drive chain 124A, the second drive chain 124B, a first drive gear 126A and a second drive gear 126B. The shaft of the reversible motor 120 is coupled to the sprocket 122. The sprocket 122 couples the first drive chain 124A to the first drive gear 126A, and the second drive chain 124B to the second drive gear 126B. The first drive gear 126A is in mesh with the first lead screw 116A. The second drive gear 126B is in mesh with the second lead screw.

The compartment 118 further comprises a power button 128, a fuse 130, a battery (not shown in FIG. 2), and a plugin 127. The power button 128 turns the electromechanical ladder 102 ON or OFF. The fuse 130 prevents the drive assembly from short-circuit. The battery powers the reversible motor 120 to drive the drive assembly. In one embodiment, the battery is a set of one or more rechargeable batteries. In another embodiment, the drive mechanism includes the reversible motor 120, the sprocket 122, the first drive chain 124A, the second drive chain 124B, the first drive gear 126A, the second drive gear 126B, the power button 128, the fuse 130 and the battery. The plugin 127 couples a charger to charge the battery.

The user turns the power button 128 ON and steps over the step 104. When the user presses the first function button 114A on the first hand rail 112A, the battery supplies the power to the reversible motor 120. The reversible motor 120 rotates the first drive gear 126A via the first drive chain 124A, and the second drive gear 126B via the second drive chain 124B in a clockwise direction. The first drive gear 126A and the second drive gear 126B rotate against the first lead screw 116A and the second lead screw. The first drive gear 126A and the second drive gear 126B being in mesh with the first lead screw 116A and the second lead screw, lift the step 104 up. The step 104 stops when the user releases the first function button 114A.

When the user presses the second function button 114B on the second hand rail 112B, the battery 132 supplies the power to the reversible motor 120. The reversible motor 120 rotates the first drive gear 126A via the first drive chain 124A and the second drive gear 126B via the second drive chain 124B in an anti-clockwise direction. The first drive gear 126A and the second drive gear 126B rotate against the first lead screw 116A and the second lead screw. The first drive gear 126A and the second drive gear 126B being in mesh with the first lead screw 116A and the second lead screw, lower the step 104 down. The step 104 stops when the user releases the second function button 114B.

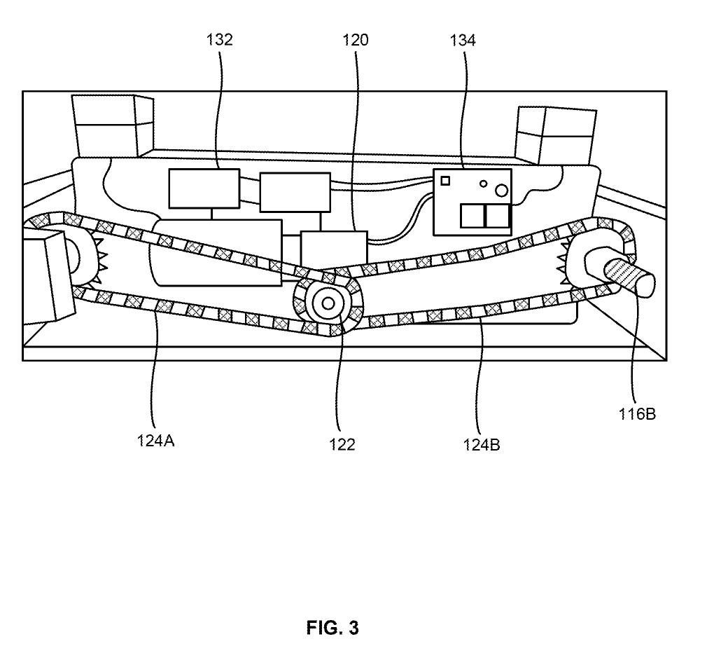

FIG. 3 is a perspective view 100C of bottom side of the front frame 106 of the electromechanical ladder 102 of FIG. 1 according to an embodiment herein. The drive mechanism further includes the battery 132 and a PCB 134. In one embodiment, the battery 132 is a set of one or more 22.2 V batteries and more particularly, a set of two 22.2 V batteries. The PCB 134 includes one or more resistors, one or more capacitors, a diode and one or more relays 136. The user sends a signal to the one or more relays 136 when the user presses the first function button 114A. The one or more relays 136 run the motor 120 in the clockwise direction using the battery 132. The motor 120 drives the first drive chain 124A and the second drive chain 124B in the clockwise direction. The first drive chain 124A and the second drive chain 124B drive the first drive gear 126A and the second drive gear 126B, respectively, in the clockwise direction. The clockwise rotation of the first drive gear 126A and the second drive gear 126B against the first lead screw 116A and the second lead screw 116B, respectively, raises the step 104 up.

The user again sends a different signal to the one or more relays 136 when the user presses the second function button 114B. The one or more relays 136 run the motor 120 in the anti-clockwise direction using the battery 132. The motor 120 drives the first drive chain 124A and the second drive chain 124B in the anti-clockwise direction. The first drive chain 124A and the second drive chain 124B drive the first drive gear 126A and the second drive gear 126B, respectively, in the anti-clockwise direction. The anti-clockwise rotation of the first drive gear 126A and the second drive gear 126B against the first lead screw 116A and the second lead screw 116B, respectively, lowers the step 104 down.

The electromechanical ladder is powered by an in-built rechargeable power source. The battery needs not be replaced when discharged. The single-button press movement of the step assists the user to get raised without any physical movement of the body. The electromechanical ladder is very beneficial for arthritis patients, elderly people and people with physical disabilities. Moreover, it should be noted that the electromechanical ladder can be modified to be attached to the back of an RV or motor home in order to allow a user to be safely raised to a desired height, including to the top of the RV or motor home.

The foregoing description of the specific embodiments will so fully reveals the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. An electromechanical ladder to raise and lower a step, wherein said electromechanical ladder comprises:
a front frame and a rear frame, wherein said step is adapted to be coupled in between said front frame and said rear frame;
one or more expandable brace members that are adapted to prevent said rear frame from getting collapsed;
a set of two or more wheels that are adapted to allow a user to carry said electromechanical ladder from one place to another;
a first hand rail and a second hand rail that are adapted to provide a support to said user;
a first function button that is adapted to raise said step up when said user presses said first function button;
a second function button that is adapted to lower said step down when said user presses said second function button;
a first lead screw and a second lead screw that are adapted to raise and lower said step up and down when said user presses said first function button and said second function button;
a compartment wherein said compartment comprises;
a power button that is adapted to turn said electromechanical ladder ON and OFF;
a fuse that is adapted to prevent damage to said electromechanical ladder;
a battery that is adapted to drive said electromechanical ladder;
a printed circuit board, wherein said printed circuit board comprises:
one or more resistors;
one or more capacitors; and
one or more relays;
a motor that is adapted to rotate in clockwise direction and anticlockwise direction;
a sprocket that is coupled to said motor; and
a first drive chain and a second drive chain that are adapted to rotate in same direction with same speed simultaneously, wherein said first drive chain and said second drive chain transfer rotary motion to said first lead screw and said second lead screw via a first drive gear and a second drive gear.

2. The electromechanical ladder of claim 1, wherein said rear frame of said electromechanical ladder is collapsible.

3. The electromechanical ladder of claim 1, wherein said first lead screw and said second lead screw are square thread type lead screw.

4. The electromechanical ladder of claim 1, wherein said first lead screw and said second lead screw rotate simultaneously in same direction with same speed.

5. The electromechanical ladder of claim 1, wherein said battery is a set of one or more rechargeable batteries.

6. The electromechanical ladder of claim 1, wherein said motor is a reversible motor.

7. The electromechanical ladder of claim 1, wherein said motor rotates in clockwise direction when said user presses said first function button

8. The electromechanical ladder of claim 1, wherein said motor rotates in anticlockwise direction when said user presses said second function button.

9. An electromechanical ladder to raise and lower a step, wherein said electromechanical ladder comprises:
a front frame and a collapsible rear frame wherein said step is adapted to be coupled in between said front frame and said collapsible rear frame;
one or more expandable brace members that are adapted to prevent said collapsible rear frame from getting collapsed;
a set of two or more wheels that are adapted to allow a user to carry said electromechanical ladder from one place to another;
a first hand rail and a second hand rail that are adapted to provide a support to said user;
a first function button that is adapted to raise said step up when said user presses said first function button;
a second function button that is adapted to lower said step down when said user presses said second function button;
a first lead screw and a second lead screw that are adapted to raise and lower said step up and down when said user presses said first function button and said second function button;
a compartment wherein said compartment comprises;
a power button that is adapted to turn said electromechanical ladder ON and OFF;
a fuse that is adapted to prevent damage to said electromechanical ladder; and
a set of two rechargeable batteries that are adapted to drive said electromechanical ladder;
a printed circuit board, wherein said printed circuit board comprises:
one or more resistors;
one or more capacitors; and
one or more relays;
a reversible motor that is adapted to rotate in clockwise direction and anticlockwise direction;
a sprocket that is coupled to said motor;
a first drive chain and a second drive chain that are adapted to rotate in same direction with same speed simultaneously, wherein said first drive chain and said second drive chain transfer rotary motion to said first lead screw and said second lead screw via a first drive gear and a second drive gear.

10. The electromechanical ladder of claim 8, wherein said first lead screw and second lead screw are square thread type lead screw.

11. The electromechanical ladder of claim 8, wherein said reversible motor rotates in clockwise direction when said user presses said first function button

12. The electromechanical ladder of claim 8, wherein said reversible motor rotates in anticlockwise direction when said user presses said second function button.
